(19) United States
(12) Patent Application Publication
(10) Pub. No.: US 2017/0286392 A1
(43) Pub. Date: Oct. 5, 2017

(54) METHOD AND ELECTRONIC DEVICE FOR DISPLAYING A WEB PAGE

(71) Applicant: GUANGZHOU UCWEB COMPUTER TECHNOLOGY CO., LTD., Guangzhou (CN)

(72) Inventor: Xiaozhen WANG, Guangzhou (CN)

(73) Assignee: GUANGZHOU UCWEB COMPUTER TECHNOLOGY CO., LTD., Guangzhou (CN)

(21) Appl. No.: 15/504,162

(22) PCT Filed: Apr. 21, 2015
(86) PCT No.: PCT/CN2015/077050

§ 371 Date: Feb. 15, 2017

(51) Int. Cl. G06F 17/27; G06F 17/30

(52) U.S. Cl. CPC G06F 17/2705; G06F 17/30997; G06F 17/3089; G06F 17/272

(57) ABSTRACT

Methods and electronic devices for displaying a web page are provided herein. In an exemplary method, metadata of a web page can be obtained. The metadata can specify a first-screen key element and include a first-screen-strategy extended attribute. A value of the first-screen-strategy extended attribute can indicate whether a page-defined first-screen display strategy is mandatory or optional. An element of the web page can be parsed in such a way as to determine whether the element is the first-screen key element. When the element is the first-screen key element, a first screen of the web page can be displayed. When the element is not the first-screen key element and a first-screen display criterion is met, a first screen of the web page can be displayed. The first-screen display criterion can be a function of the value of the first-screen-strategy extended attribute.

### CROSS REFERENCE TO RELATED APPLICATIONS

This application claims priority to International Application No. PCT/CN2015/077050, filed on Apr. 21, 2015, which is incorporated herein by reference in their entirety.

### FIELD OF THE DISCLOSURE

The present disclosure generally relates to the field of electronic devices and communications technology and, more particularly, relates to methods and electronic devices for displaying a web page.

### BACKGROUND

With arrival of 4G era, using a mobile browser to access the Internet has become a mainstream method for obtaining information. An advantage of using a mobile browser is that a web page can be browsed at any time by using fragments of time. With increased speed of mobile networks and improved performance of mobile device hardware, higher requirements have also been imposed on speed of displaying a web page. According to statistical data, users are the most satisfied when a time length needed for opening a web page is 2 seconds or less. The longest wait time for opening a web page that users can endure ranges from 6 seconds to 8 seconds. If the time length needed for opening a web page is more than 8 seconds, most users choose to give up visiting the web page.

For a mobile browser, a user is mainly concerned with two time points of displaying a page. The first time point is a time point of displaying the page for the first moment, also referred to as a time point of “first-moment display”. At such a time point, usually only a small portion of contents of a page is displayed. The small portion of contents may be, e.g., title text of the page and/or the like, and usually only occupies about one tenth of an entire area of a display screen. Such a portion of the web page can be referred to as a “first moment” of the web page. The second time point is a time point of displaying a page such that the page substantially fills the entire display screen for the first time, also referred to as a time point of “first-screen display”.

The previously-mentioned time length needed for opening a web page usually refers to the time length needed for “first-screen display”, i.e., the time length from requesting a web page to completion of the “first-screen display”. That is, users are the most satisfied when the time length needed for “first-screen display” is 2 seconds or less. Thus, if a mobile browser can accelerate first-screen display, i.e. reduce the time length needed for first-screen display, the mobile browser can create desired experience for the users.

However, existing speed for first-screen display still need to be improved. The disclosed methods and devices are directed to solve one or more problems set forth above and other problems. More specifically, the disclosure provides solutions to the technical problems of improving speed for web page display to satisfy the users' expectation when opening the web page, and further contributes advancement of computer technology as well as network technology.

### BRIEF SUMMARY OF THE DISCLOSURE

One aspect of the present disclosure includes methods for displaying a web page. In an exemplary method, metadata of a web page can be obtained. The metadata can specify a first-screen key element and include a first-screen-strategy extended attribute. A value of the first-screen-strategy extended attribute can indicate whether a page-defined first-screen display strategy is mandatory or optional. An element of the web page can be parsed in such a way as to determine whether the element is the first-screen key element. When the element is the first-screen key element, a first screen of the web page can be displayed. When the element is not the first-screen key element and a first-screen display criterion is met, a first screen of the web page can be displayed. The first-screen display criterion can be a function of the value of the first-screen-strategy extended attribute.

Another aspect of the present disclosure includes electronic devices for displaying a web page. An exemplary electronic device can include a processor, a display system, and a memory. The memory can have encoded instructions thereon that cause the electronic device to display a web page on the display system by a process. The process can include obtaining metadata of a web page. The metadata can specify a first-screen key element and include a first-screen-strategy extended attribute. A value of the first-screen-strategy extended attribute can indicate whether a page-defined first-screen display strategy is mandatory or optional. The process can further include parsing an element of the web page in such a way as to determine whether the element is the first-screen key element. When the element is the first-screen key element, a first screen of the web page can be displayed. When the element is not the first-screen key element and a first-screen display criterion is met, a first screen of the web page can be displayed. The first-screen display criterion can be a function of the value of the first-screen-strategy extended attribute.

Another aspect of the present disclosure includes a non-transitory computer-readable storage medium containing executable computer programs. When executed by an electronic device, the computer programs can cause a web page to be displayed on a display system of the electronic device by a process. The process can include obtaining metadata of a web page. The metadata can specify a first-screen key element and include a first-screen-strategy extended attribute. A value of the first-screen-strategy extended attribute can indicate whether a page-defined first-screen display strategy is mandatory or optional. The process can further include parsing an element of the web page in such a way as to determine whether the element is the first-screen key element. When the element is the first-screen key element, a first screen of the web page can be displayed. When the element is not the first-screen key element and a first-screen display criterion is met, a first screen of the web page can be displayed. The first-screen display criterion can be a function of a value of the first-screen-strategy extended attribute.

Other aspects of the present disclosure can be understood by those skilled in the an in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the disclosure.

FIG. 1A depicts an exemplary system for displaying a web page in accordance with various disclosed embodiments;

FIG. 1B depicts a block diagram illustrating a structure diagram of an exemplary electronic device for displaying a web page in accordance with some embodiments;

FIG. 2 depicts a flow diagram of an exemplary method for displaying a web page in accordance with various disclosed embodiments;

FIG. 3 depicts a flow diagram of another exemplary method for displaying a web page in accordance with various disclosed embodiments;

FIG. 4 depicts a document portion of a web page document provided to a browser in accordance with various disclosed embodiments;

FIG. 5A depicts a portion of coded instructions of a browser in accordance with various disclosed embodiments;

FIG. 5B depicts another portion of coded instructions of a browser in accordance with various disclosed embodiments;

FIG. 6 depicts a flow diagram of another exemplary method for displaying a web page in accordance with various disclosed embodiments;

FIG. 7 depicts a flow diagram of another exemplary method for displaying a web page in accordance with various disclosed embodiments; and

FIG. 8 depicts a flow diagram of another exemplary method for displaying a web page in accordance with various disclosed embodiments.

### DETAILED DESCRIPTION

Reference will now be made in detail to exemplary embodiments of the disclosure, which are illustrated in the accompanying drawings. Wherever possible, the same reference numbers will be used throughout the drawings to refer to the same or like parts.

The present disclosure can address certain problems in mobile electronic device technology. Using the methods and the electronic devices as disclosed herein, a first screen of a web page can be displayed on a display screen within a shortened time length. Further, content of the first screen can be displayed accurately.

A user of an electronic device may request a web page via a certain operation on the browser on the electronic device. An operation can include, but is not limited to, typing a website address in address bar, clicking on back/forward button, selecting a website in a bookmarking menu, clicking on a link to a website, or the like. The web page can then be downloaded from a server according to a plurality of requests from the browser. In another example, the webpage may be previously stored on the memory of on the electronic device and can be retrieved by the browser.

Generally, displaying a requested page on a display of an electronic device is a function of a rendering engine of a browser installed on the electronic device. The rendering engine can be responsible for displaying requested content.

The source code of the web page can be written in HyperText Markup Language (HTML), or any other programming language that can provide similar functionalities in accordance with various embodiments. For illustrative purposes, in certain embodiments described in the present disclosure, the web page document is an HTML document. If content of a requested page is HTML, the rendering engine can parse HTML and Cascading Style Sheets (CSS), and display the parsed content on the display.

In various embodiments, a page can include a document that is suitable for any appropriate information system and can be processed and displayed by a browser. A web page (or webpage) is a web document that is suitable for the World Wide Web and can be processed and displayed by a web browser. Although “web page” is used for illustrative purposes in certain embodiments of the present disclosure, the present disclosure is not limited to a web page, and can be any other appropriate page.

HTML documents are made up by HTML elements. Generally, in order to display a web page, the rendering engine can start parsing the HTML document and convert elements to Document Object Model (DOM) nodes in a tree called the “content tree”. The engine can parse the style data, both in external CSS files and in style elements. Styling information together with visual instructions in the HTML can be used to create a render tree.

The render tree can contain rectangles with visual attributes like color and dimensions. The rectangles can be in the right order to be displayed on the screen.

After the construction of the render tree, the nodes, i.e., the elements, can go through a “layout” process. In a layout process, each node is given exact coordinates where the node should appear on the display. In various embodiments as disclosed herein, “layout process an element” refers to “perform a layout process on an element”.

The rendering engine can maintain a “layout region”. The layout region is a virtual representation of a display screen area of the electronic device. The layout-processed element can be placed in the layout region as the element should appear on the actual display screen of the electronic device.

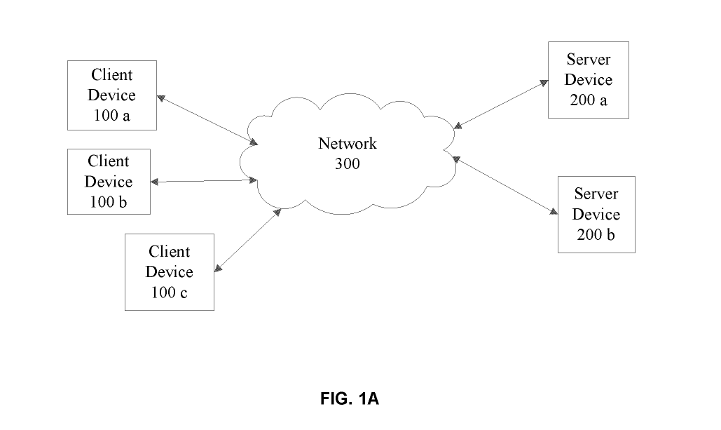

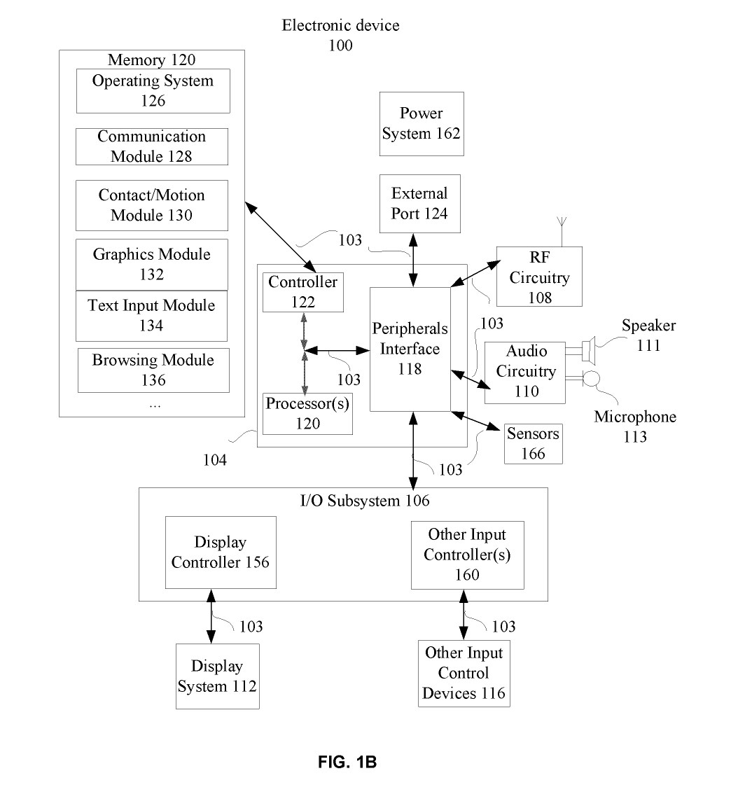

The layout process can be followed by a painting process, during which the render tree can be traversed and the rendering engine's “paint( )” method can be called to display content on the screen. That is, via the painting process, the layout region is displayed on the actual display screen of the electronic device. To paint each node, user interface (UI) backend layer can be used. The UI backend layer can use appropriate operating system user interface methods. Thus, during painting of the elements, the browser may interact with various components of the operating system, e.g., sending command to the operating system to make the display screen of the electronic device display the painted elements. The various components of the operating system may include, e.g., the graphics module 132 as shown in FIG. 1B.

In order to in prove first-screen display of a web page, mobile browser manufacturers use certain methods for determining or specifying a time point of first-screen display. When the specified time point of first-screen display is reached, the browser displays one or more elements on the screen as a first screen of the web page.

In one method, a time point of first-screen display is determined according to a position of an element. That is, each time after a browser completes a layout process of an element, the browser determines a coordinate of a top boundary, a coordinate of a left boundary, a width, and a height of contents of the element. When the layout process results in a coordinate of the element exceeding the display screen, it is determined that the elements having already been layout processed can fill the screen and that the time point of first-screen display has been reached. Thus, at that time, the page is displayed using any elements that have been appropriately processed. A coordinate of the element exceeding the display screen refers to a coordinate of the bottom of the display screen being smaller than a sum of the coordinate of the top boundary of the element and the height of the element, i.e., screen bottom<element top+element height. However, all the coordinates, width, and height of the element may be obtained from a current layout process. The coordinates, the width, and the height of the element may be further affected by other factors, e.g., loading a new style, accessing an internal resource, and/or JavaScript (js) dynamic adjustment.

In another method, a time point of first-screen display is determined according to a preset time length of opening a page. That is, when a preset time length has passed since the start of opening the page, it is determined that the time point of first-screen display has been reached. For example, assuming a preset time length of opening a page is one second, after attempting to open a page for a second, it can be determined that the time point of first-screen display has been reached. Thus, at that time, the first screen of the page is displayed using any elements having already been appropriately processed, even if such elements are not able to fill the display screen, or the number of such elements is small or is even zero.

However, the above methods can only correspond to a typical web page or a web page that has a large amount of user access. Certain types of special pages, or pages having special contents that can affect processing time, cannot be processed by the above methods used on a browser. In those cases, the first-screen display can be significantly delayed.

In certain proposed methods, web page developers may control a web page to decide the time point of first-screen display in order to accelerate first-screen display. However, when a first-screen display strategy defined in a web page (i.e., page-defined first-screen display strategy) conflicts with a first-screen display strategy defined by a browser (i.e., browser-defined first-screen display strategy), the browser may not be able to properly process first-screen display of a web page. Thus, first-screen display of a web page may also be delayed.

Besides determining the time point of first-screen display, certain other factors may also result in delay of first-screen display. For example, a web page may have a plurality of elements to be displayed. The plurality of elements may include a first element, a second element, a third element and so on. Typically, the following process is performed. The first element is parsed and layout processed. A painting process is then performed. Next, the second element is parsed and layout processed. A painting process is then performed.

Typically, after the layout process of each element, a layout-region-change request is generated. Responsive to the layout-region-change request, the rendering engine re-calculates whether the layout region is changed due to the previously layout process. When the layout region is changed, a screen-paint request is sent. Responsive to the screen-paint request, a painting process is performed to paint and display the layout region. In other words, the generating of the layout-region-change request can cause the layout region to be updated, and entirely or partially painted and displayed.

For many operating systems, such a painting process after updating the layout region may or may not be completed, because the painting process may be stopped when the rendering engine takes resources away from the painting process to parsing and layout processing the next element. For example, assuming an updated layout region has four elements, when a painting process is performed responsive to the screen-paint request, the painting process may only have time to paint and display two elements before having to stop. After the parsing and layout process a next element, a painting process can again be performed responsive to the screen-paint request, and based on the next updated layout region.

In many cases, the layout process of an element can cause the layout region to change. Therefore, if the browser is configured to generate a layout-region-change request after the layout process of each element, a screen-paint request is often sent.

The screen-paint request is typically categorized as a message-type notification. In various operating systems, priority of processing a message-type notification can be lower than priority of other actions such as parsing and layout processing a next element. Thus, there can be pause or delay when the operating system needs to respond to the screen-paint request. That is, before the browser and/or the operating system responds to the screen-paint request, the screen-paint request may need to wait for a certain amount time during which the browser and/or the operating system is performing processes related to layout. On the other hand, the layout process of the next element may need to pause for performing the painting process, so the layout process may also need to wait for a certain amount of time.

Therefore, updating the layout region after each layout process can introduce a delay during the first-screen display of a web page. However, updating the layout region after each layout process may not be necessary. For example, after the layout process of the second element, a layout-region-change request is generated. Responsive to a layout-region-change request, the layout region is updated and painted after the layout process of the second element. The updated layout region includes the second element. The third element is then parsed and layout processed. If the third element covers the second element in the layout region, the time length previously spent on updating and painting the layout region based on the layout process of the second element, and any delay associated with the layout-region-change request sent after the layout process of the second element, can become an unnecessary waste of time.

To further improve the above methods, various embodiments provide methods and electronic devices for displaying a web page. FIG. 1A depicts an exemplary system consistent with various disclosed embodiments.

In a system as shown in FIG. 1A, client devices 100 a, 100 b, and 100 c can be configured to communicate, via network 300, with server devices 200 a and 200 b. Network 300 may correspond to a local area network (LAN), a wide area network (WAN), a corporate intranet, the public Internet, a wireless or cellular network, or any other type of network configured to provide a communications path between networked computing devices. The network 300 may also correspond to a combination of one or more LANs, WANs, corporate intranets, and/or the public Internet.

Although FIG. 1A shows two server devices, the system may include one, three, four, tens, or more server devices, without limitation. Server devices 200 a and 200 b can be configured to perform one or more services, as requested by client devices 100 a, 100 b, and/or 100 c. For example, server device 200 a and/or 200 b can provide content to client devices 100 a-100 c. The content can include, but is not limited to, web pages, hypertext, scripts, binary data such as compiled software, images, audio, and/or video. The content can include compressed and/or uncompressed content. The content can be encrypted and/or unencrypted. Other types of content are possible as well.

As another example, server device 200 a and/or 200 b can provide client devices 100 a-100 c with access to software for database, search, computation, graphical, audio, video, World Wide Web/Internet utilization, and/or other functions. Many other examples of server devices are possible as well.

Each of the server devices 200 a and 200 b and client devices 100 a-100 c can include an appropriate computing device, respectively. Each computing device can be configured to perform one or more functions of the server devices 200 a and 200 b, network 300, and/or the one or more of client devices 100 a-100 c.

The server device 200 a or 200 b can include a computing device that includes a user interface module, a network communications interface module, one or more processors, and memory, all of which may be physically and/or communicatively linked together via a system bus, network, or other connection, mechanism. The user interface module can be configured to send data to and/or receive data from the client devices 100 a-100 c. The Network communications interface module can include one or more wireless interfaces and/or one or more wireline interfaces that are configurable to communicate via a network, such as network 300 shown in FIG. 1A. The processors can include one or more general-purpose processors and/or one or more special purpose processors (e.g., digital signal processors, application specific integrated circuits, etc.). Processors can be configured to execute computer-readable program instructions that are contained in the memory and/or other instructions as described herein. The memory can include one or more computer-readable storage media that can be read and/or accessed by at least one of processors.

Although FIG. 1A only shows three client devices, the system may serve tens, hundreds, or thousands of client devices. Moreover, client devices 100 a, 100 b, and 100 c (or any additional client devices) may be any kind of computing device, such as an ordinary laptop computer, desktop computer, network terminal, wireless communication device (e.g., a cell phone, smart phone, or a tablet computer), and so on. In certain embodiments, client devices 100 a, 100 b, and 100 c may be dedicated to the design and use of software applications. In other embodiments, client devices 100 a, 100 b, and 100 c may be general purpose computers that are configured to perform a number of tasks and need not be dedicated to software development tools.

FIG. 1B depicts a block diagram illustrating a structure diagram of an exemplary client device in accordance with some embodiments. As shown in FIG. 1B, an electronic device 100 may include a memory 102 (which may include one or more computer readable storage mediums), a memory controller 122, one or more processing units (CPU's) 120, a peripherals interface 118, RF circuitry 108, audio circuitry 110, a speaker 111, a microphone 113, an input/output (I/O) subsystem 106, other input or control devices 116, and an external port 124. These components may communicate over one or more communication buses or signal lines 103.

Further, the electronic device 100 may include a display system 112. In certain embodiments, the display system 112 can include a touch-sensitive display, which can also be called a “touch screen”. It should be appreciated that the electronic device 100 is only one example of an electronic device 100, and that the electronic device 100 may have more or fewer components than shown, may combine two or more components, or may have a different configuration or arrangement of the components. The various components shown in FIG. 1B may be implemented in hardware, software or a combination of both hardware and software, including one or more signal processing and/or application-specific integrated circuits.

Memory 102 may include high-speed random access memory (RAM) and may also include non-volatile memory, such as one or more magnetic disk storage devices, flash memory devices, or other non-volatile solid-state memory devices. Access to memory 102 by other components of the electronic device 100, such as the CPU 120 and the peripherals interface 118, may be controlled by the memory controller 122.

The peripherals interface 118 couples the input and output peripherals of the device to the CPU 120 and memory 102. The one or more processors 120 run or execute various software programs and/or sets of instructions stored in memory 102 to perform various functions for the electronic device 100 and to process data.

In some embodiments, the peripherals interface 118, the CPU 120, and the memory controller 122 may be implemented on a single chip, such as a chip 104. In some other embodiments, they may be implemented on separate chips.

The RF (radio frequency) circuitry 108 receives and sends RF signals, also called electromagnetic signals. The RF circuitry 108 converts electrical signals to/from electromagnetic signals and communicates with communications networks and other communications devices via the electromagnetic signals. The RF circuitry 108 may include any appropriate circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry 108 may communicate with networks, such as the Internet, also referred to as the World Wide Web (WWW), an intranet and/or a wireless network, such as a cellular telephone network, a LAN and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or instant Messaging and Presence Service (IMPS)), and/or Short Message Service (SMS)), or any other suitable communication protocol, including communication protocols not yet developed as of the filing date of this disclosure.

The audio circuitry 110, the speaker 111, and the microphone 113 provide an audio interface between a user and the electronic device 100. The audio circuitry 110 receives audio data from the peripherals interface 118, converts the audio data to an electrical signal, and transmits the electrical signal to the speaker 111. The speaker 111 converts the electrical signal to human-audible sound waves. The audio circuitry 110 also receives electrical signals converted by the microphone 113 from sound waves. The audio circuitry 110 converts the electrical signal to audio data and transmits the audio data to the peripherals interface 118 for processing. Audio data may be retrieved from and/or transmitted to memory 102 and/or the RF circuitry 108 by the peripherals interface 118. In some embodiments, the audio circuitry 110 also includes a headset jack. The headset jack provides an interface between the audio circuitry 110 and removable audio input/output peripherals, such as output-only headphones or a headset with both output (e.g., a headphone for one or both ears) and input (e.g., a microphone).

The I/O subsystem 106 couples input/output peripherals on the electronic device 100, such as the display system 112 and other input/control devices 116, to the peripherals interface 118. The I/O subsystem 106 may include a display controller 156 and one or ore input controllers 160 for other input or control devices. The one or more input controllers 160 receive/send electrical signals from/to other input or control devices 116. The other input/control devices 116 may include physical buttons (e.g., push buttons, rocker buttons, etc.), dials, slider switches, joysticks, click wheels, and so forth. In some alternate embodiments, input controller(s) 160 may be coupled to any (or none) of the following: a keyboard, infrared port, USB port, and a pointer device such as a mouse.

When the display system 112 includes a touch screen, the touch screen can provide an input interface and an output interface between the device and a user. The display controller 156 receives and/or sends electrical signals from/to the touch screen. The touch screen can display visual output to the user. The visual output may include graphics, text, icons, video, and any combination thereof (collectively termed “graphics”). In some embodiments, some or all of the visual output may correspond to user-interface objects, further details of which are described below.

The display system 112 includes a display screen. Me display screen is a device made using certain display technology to provide a surface area for displaying visual content to a user. For example, the visual content can include content of a web page. The display screen may be made using LCD (liquid crystal display) technology, OLED (organic light-emitting diode) technology or LPD (light emitting polymer display) technology, although any other appropriate display technologies may be used in other embodiments. When the display screen of the display system 112 includes a touch screen, the touch screen and the display controller 156 may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with the touch screen.

The display system 112 may have a resolution in excess of 100 dpi. In an exemplary embodiment, the display system 112 can have a resolution of approximately 160 dpi.

The electronic device 100 also includes a power system 162 for powering the various components. The power system 162 may include a power management system, one or more power sources (e.g., battery, alternating current (AC)), a recharging system, a power failure detection circuit, a power converter or inverter, a power status indicator (e.g., a light-emitting diode (LED)) and any other components associated with the generation, management and distribution of power in portable devices.

The electronic device 100 may also include one or more sensors 166. The sensors 166 may include, e.g., a proximity sensor, an accelerometer, and/or the like. The sensors 166 can be coupled to the peripherals interface 118. Alternately, the sensors 166 may be coupled to an input controller 160 in the I/O subsystem 106.

In some embodiments, the software components stored in memory 102 may include an operating system 126, a communication module (or set of instructions) 128, a contact/motion module (or set of instructions) 130, a graphics module (or set of instructions) 132, a text input module (or set of instructions) 134, and a browsing module (or set of instructions) 136.

The operating system 126 (e.g., Darwin, RTXC, LINUX, UNIX, OS X, WINDOWS, or an embedded operating system such as VxWorks) includes various software components and/or drivers for controlling and managing general system tasks (e.g., memory management, storage device control, power management, etc.) and facilitates communication between various hardware and software components.

The communication module 128 facilitates communication with other devices over one or more external ports 124 and also includes various software components for handling data received by the RF circuitry 108 and/or the external port 124. The external port 124 (e.g., Universal Serial Bus (USB), FIREWIRE, etc.) is adapted for coupling directly to other devices or indirectly over a network (e.g., the Internet, wireless LAN, etc.).

The contact/motion module 130 may detect contact with the touch screen (in conjunction with the display controller 156) and other touch sensitive devices (e.g., a touchpad or physical click wheel). The contact/motion module 130 includes various software components for performing various operations related to detection of contact, such as determining if contact has occurred, determining if there is movement of the contact and tracking the movement across the touch screen, and determining if the contact has been broken (i.e., if the contact has ceased). The graphics module 132 includes various known software components for rendering and displaying graphics on the touch screen, including components for changing the intensity of graphics that are displayed.

The text input module 134, which may be a component of graphics module 132, provides soft keyboards for entering text in various applications (e.g., browsing module (or browser) 136, and any other application that needs text input).

In conjunction with RF circuitry 108, display system 112, display controller 156, contact module 130, graphics module 132, and text input module 134, the browser module 136 may be used to browse the Internet, including searching, linking to, receiving, and displaying web pages or portions thereof, as well as attachments and other files linked to web pages. Embodiments of user interfaces and associated processes using the browser module 136 are described further below.

Each of the above identified modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. In some embodiments, memory 102 may store a subset of the modules and data structures identified above. Furthermore, memory 102 may store additional modules and data structures not described above.

Various embodiments provide methods and electronic devices for displaying a web page. A disclosed method for displaying a web page can be implemented on an electronic device for displaying a web page. The electronic device for displaying a web page can have a structure of a client device as depicted in FIG. 1B, and can be configured to accomplish the functions and features for displaying a web page. In various embodiments, the electronic device for displaying a web page can include a browsing module (or browser) 136, e.g., as shown in FIG. 1B. The browser can be configured to implement the disclosed method for displaying a web page. Further, in certain embodiments, the electronic device for displaying a web page can include a mobile phone, a smart phone, a tablet computer, or the like.

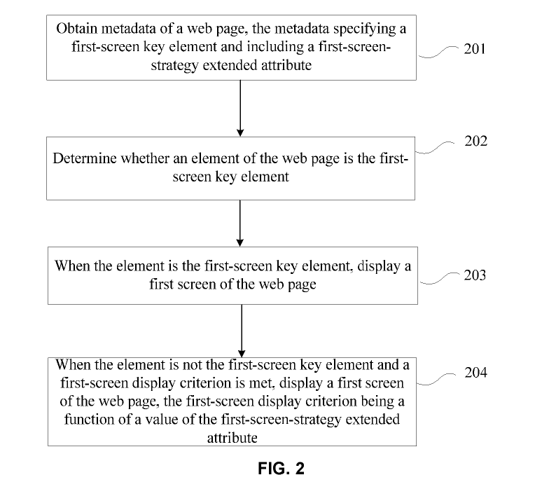

FIG. 2 depicts a flow diagram of an exemplary method for displaying a web page in accordance with various disclosed embodiments. As shown in FIG. 2, an exemplary method can include the following process.

In Step 201, metadata of a web page is obtained. The metadata can specify a first-screen key element and a first-screen-strategy extended attribute. A value of the first-screen-strategy extended attribute can also be obtained.

In Step 202, it is determined whether an element of the web page is the first-screen key element.

In Step 203, when an element is the first-screen key element, a first screen of the web page is displayed. In Step 204, when the element is not the first-screen key element and a first-screen display criterion is met, a first screen of the web page is displayed. The first-screen display criterion can be a function of a value of the first-screen-strategy extended attribute.

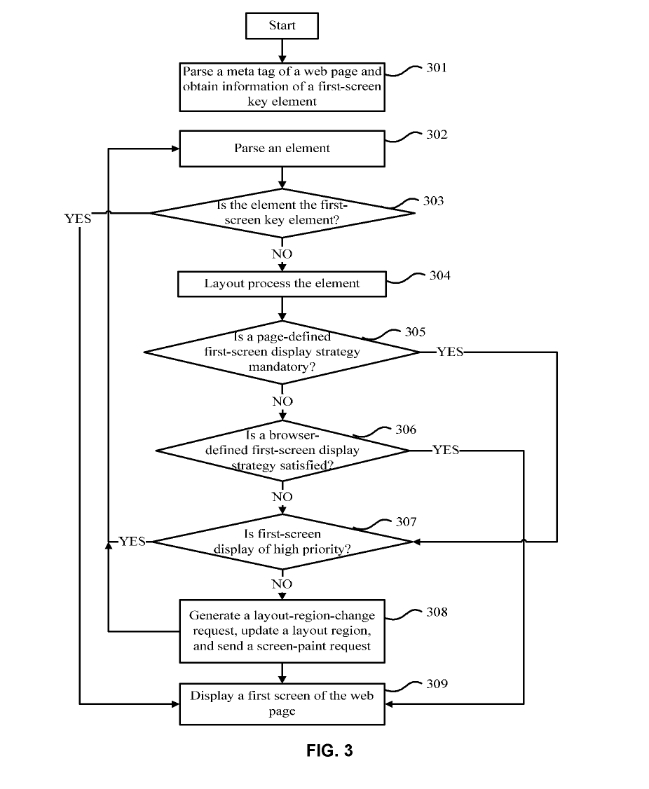

To further illustrate the method depicted in FIG. 2, various embodiments are disclosed throughout the present disclosure. FIG. 3 depicts a flow diagram of another exemplary method for displaying a web page in accordance with various disclosed embodiments. As shown in FIG. 3, an exemplary method can include the following process. Such a process can implement the method as depicted in FIG. 2.

In Step 301, metadata of a web page is obtained. The metadata of a web page can include information about data of the web page. For example, the metadata can be provided using a <meta> tag in HTML. The metadata can thus be obtained by parsing the <meta> tag.

Generally, a <meta> tag can define a metadata element. Metadata provided using a <meta> tag is not displayed on the page, but can be machine parsable. The metadata elements are typically used to specify page description, keywords, author of the document, last modified, and other metadata. The metadata can instruct the browser on how to display content or reload page.

For example, the <meta> tag providing the metadata can have a grammar as follows:
<meta name=“first-screen-paint” content=“element-id:specified element ID; element-paint:must/optionally; priority:high/normal”>

In the above grammar, “name” attribute can be used for specifying a name for the metadata. The value of the “name” attribute is the name for the metadata. The value of the “name” attribute can be any name that is recognized and supported by the browser. In the example as above, the name of the metadata is “first-screen-paint”. When the browser parses the metadata of the name “first-screen-paint”, the browser can recognize that a value of this metadata provides instructions on first-screen display of a webpage.

The “content” attribute can give a value associated with the “name” attribute. That is, the value of the “content” attribute can be the value associated with the name for the metadata. In the example as above, the value of the “content” attribute is the text string “element-id:specified element ID; element-paint:must/optionally; priority:high/normal”, and such a value is associated with the metadata name “first-screen-paint”.

As shown in the example above, the value of the “content” attribute can include one or more extended attributes. Each extended attribute can have a value, respectively. In various embodiments, an “extended attribute” is an attribute that may or may not be commonly supported across browsers made by different browser manufacturers, but that is recognized and supported by a certain browser made by a certain browser manufacturer. An “extended attribute” can thus be an extension beyond existing HTML attributes, and can be defined by the browser manufacturer by extending the list of existing and universally-recognized HTML attributes. A web page developer can add the “extended attribute” to a web page and choose a value for the “extended attribute”.

The extended attributes can include a key-element extended attribute “element-id”. When the browser parses the key-element extended attribute “element-id” in the metadata of the name “first-screen-paint”, the browser can recognize that the value of the key-element extended attribute “element-id” specifies a first-screen key element. The first-screen key element can be specified using an appropriate method. In the example as shown above, the value of the key-element extended attribute “element-id” is an ID of an element. According to World Wide Web Consortium (W3C), in HTML, an ID can be uniquely associated with an element in a web page.

Further, the extended attributes can include a first-screen-strategy extended attribute “element-paint”. When the browser parses the first-screen-strategy extended attribute “element-paint” in the metadata of the name “first-screen-paint”, the browser can recognize that the value of the first-screen-strategy extended attribute “element-paint” instructs the browser on what strategy to execute for first-screen display of the web page. The strategy can be specified using an appropriate method. In the example as shown above, the strategy is specified by setting the value of the first-screen-strategy extended attribute “element-paint” to be one of “must” and “optionally”.

Further, the extended attributes can include a first-screen-priority extended attribute “priority”. When the browser parses the first-screen-priority extended attribute “priority” in the metadata of the name “first-screen-paint”, the browser can recognize that the value of the first-screen-priority extended attribute “priority” specifies a priority for displaying the first-screen of the web page. The priority can be specified using an appropriate method. In the example as shown above, the priority is specified by setting the value of the first-screen-priority extended attribute “priority” to be one of “high” and “normal”.

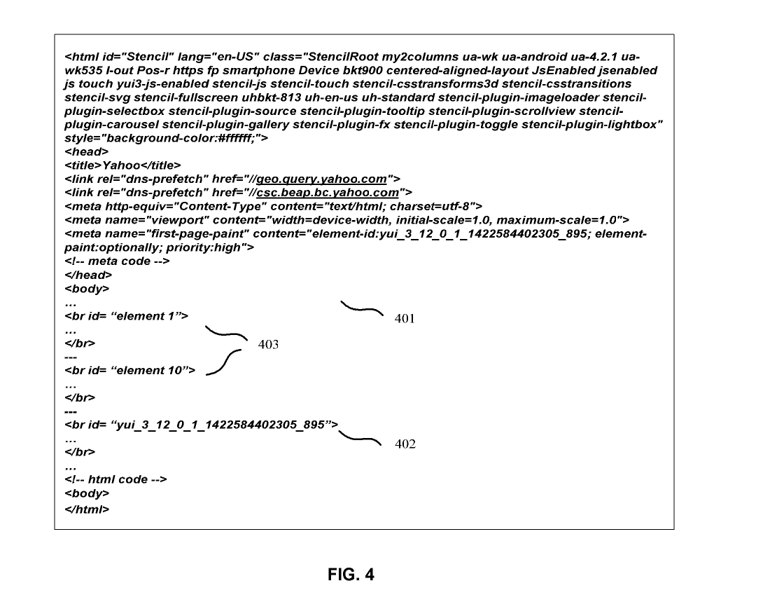

Thus, in Step 301, the browser can parse the <meta> tag and obtain information of the first-screen key element, e.g., ID of the first-screen key element. For example, FIG. 4 depicts a document portion of a web page document provided to a browser in accordance with various disclosed embodiments. The <meta> tag 401 depicts an example of the <meta> tag used in source code of the web page. The first-screen key element has an ID “yui_3_12_0_1_1422584402305_895”. The value of the first-screen-strategy extended attribute “element-paint” is “optionally”. The value of the first-screen-priority extended attribute “priority” is “high”. The element 402 having the ID “yui_3_12_0_1_1422584402305_895” is thus the first-screen key element of the web page. In the source code, one or more other elements 403 may precede the first-screen key element.

Referring to FIG. 3, in Step 302, an element is parsed. The element can be any appropriate element that the browser needs to parse prior to displaying a first screen of the web page.

In various embodiments, the portion of a web page that is displayed at the time point of “first-screen display” can be referred to as a “first screen” of the web page. In certain cases, the element that is parsed in Step 302 can be an element included in the “first screen” of the web page.

The “first screen” of the web page may or may not include elements displayed as the “first moment” of the web page. As previously mentioned, a time point of “first-moment display” is a time point at which only a small portion of the display screen of a page is occupied. In some cases, web page developer , browsers, or any other appropriate programs or parties may implement a specific process for “first-moment display”, and designate specific elements to be displayed as the “first moment” of the web page. In other cases, no specific process is performed for implementing “first-moment display”. That is, no content is displayed on the display screen as the “first moment” of the web page.

In some embodiments, the portion of a web page that is displayed at the time point of “first-screen display”, excluding the elements displayed as the “first moment” of the web page, is referred to as a “first screen” of the page. In other embodiments, the portion of a web page that is displayed at the time point of “first-screen display”, including the elements displayed as the “first moment” of the web page, is referred to as a “first screen” of the web page. However, the presently-disclosed methods and devices can be implemented regardless of whether the “first screen” of the web page includes elements displayed as the “first moment” of the web page or not.

In one example, web page developers, browsers, or any other appropriate programs or parties may implement a specific process for “first-moment display” and designate specific elements to be displayed as the “first-moment” of the web page. If the “first screen” of the web page does not include elements displayed as the “first moment” of the web page, element(s) other than the “first moment” elements, e.g., an element in the source code following the “first moment” elements, can be parsed in Step 302 in such a way as to implement the disclosed methods for displaying the first screen. If the “first screen” of the web page includes elements displayed as the “first moment” of the web page, an element, which may include one of the “first moment” elements, can be parsed in Step 302 in such a way as to implement the disclosed methods for displaying the first screen.

Referring to FIG. 3, in Step 303, whether the element is the first-screen key element is determined. When the parsed element is the first-screen key element, Step 309 is performed, and Steps 304-308 are skipped. When the parsed element is not the first-screen key element, Step 304 is performed.

In various embodiments, the metadata can specify the first-screen key element by specifying the ID of the first-screen key element. Thus, an ID of the parsed element can be compared with the ID of the first-screen key element. When the ID of the parsed element is the same as the ID of the first-screen key element, the parsed element is the first-screen key element. When the ID of the parsed element is not the same as the ID of the first-screen key element, the parsed element is not the first-screen key element.

When the parsed element is not the first-screen key element, Step 304 is performed. In the source code, one or more elements may exist before the first-screen key element. Typically, elements can be parsed in the order of appearance in the source code. Thus, an element existing before the first-screen key element can be parsed and the browser can determine that the parsed element is not the first-screen key element.

In Step 304, the element is layout processed. In Step 305, it is determined whether the value of the first-screen-strategy extended attribute “element-paint” is “must”. When the value of the first-screen-strategy extended attribute “element-paint” is “must”, Step 307 is performed. When the value of the first-screen-strategy extended attribute “element-paint” is not “must”, Step 306 is performed.

The value of the first-screen-strategy extended attribute “element-paint” can instruct the browser on what strategy to execute for first screen display of the web page. In various embodiments, a value of “must” indicates that a page-defined first-screen display strategy is mandatory.

A page-defined first-screen display strategy is a strategy defined in the source code of the web page. According to the page-defined first-screen display strategy, a first screen of the web page is displayed only when the first-screen key element is parsed. That is, the first-screen key element marks a boundary in the source code of the web page. A first screen of the web page is displayed by painting one or more elements that have been parsed and layout processed prior to the parsing of the first-screen key element. With the page-defined first-screen display strategy being mandatory, the first screen of the webpage can only be displayed when an element is determined to be the first-screen key element

A browser-defined first-screen display strategy can include certain strategies as previously described in the present disclosure, such as determining a time point of first-screen display according to a position of an element, or according to a preset time length of opening a page. With the page-defined first-screen display strategy being mandatory, a first screen of the web page is displayed without determining whether a browser-defined first-screen display strategy is satisfied.

Therefore, when the value of the first-screen-strategy extended attribute “element-paint” is “must”, Step 107 is performed. Accordingly, Step 306 is skipped.

In various embodiments, a value of “optionally” indicates that a page-defined first-screen display strategy is optional and not mandatory. That is, when an element is not the first-screen key element, it can be determined whether the browser-defined first-screen display strategy is satisfied. Therefore, when the value of the first-screen-strategy extended attribute “element-paint” is not “must”, Step 306 is performed.

In Step 306, it is determined whether the browser-defined first-screen display strategy is satisfied. When the browser-defined first-screen display strategy is satisfied, Step 309 is performed. When the browser-defined first-screen display strategy is not satisfied, Step 307 is performed.

In Step 307, it is determined whether the value of the first-screen-priority extended attribute “priority” is “high”. When the value of the first-screen-priority extended attribute “priority” is “high”, Step 302 is performed. When the value of the first-screen-priority extended attribute “priority” is not “high”, Step 308 is performed.

The value of the first-screen-priority extended attribute “priority” can specify a priority for displaying the first-screen of the web page. In various embodiments, a value of “high” indicates that first-screen display is of high priority. Thus, a layout-region-change request is not generated after a layout process. As previously described, generating a layout-region-change request may cause delay of first-screen display.

Therefore, when the value of the first-screen-priority extended attribute “priority” is “high”, Step 302 is performed. That is, a next element can be parsed. Accordingly, Step 308 is skipped.

In various embodiments, a value of “normal”, i.e., not “high”, indicates that first-screen display is of normal priority. Thus, a layout-region-change request can be generated after a layout process. Delay caused by generating a layout-region-change request may be acceptable. Therefore, when the value of the first-screen-priority extended attribute “priority” is not “high”, Step 308 is performed.

In Step 308, a layout-region-change request is generated. Responsive to the layout-region-change request, the rendering engine can re-calculate whether the layout region is changed due to the previously layout process. When the layout region has changed, a screen-paint request can be sent. Responsive to the screen-paint request, a painting process can be performed to paint and display the updated layout region. In this case, some or all of the elements that have been parsed and layout processed so far can be displayed on the screen of the electronic device. After Step 308 is performed, Step 302 can be performed. That is, a next element can be parsed.

In Step 309, the first screen of the web page is displayed. Step 309 may follow Step 303 or Step 306.

As previously described, in Step 303, when the parsed element is the first-screen key element, Step 309 is performed. That is, the first-screen key element marks a boundary in the source code of the web page. When the first-screen key element is parsed, the marked boundary has been reached. When the marked boundary is reached, the first-screen display process of the web page must be completed.

In some embodiments, the value of the first-screen-priority extended attribute “priority” is “high”. Step 308 is skipped for each element that has been layout processed. Thus, in Step 309, all elements that have been parsed and layout processed can be painted. The first-screen display process of the web page is thus completed. Before such a painting process, none of the elements previously parsed (in Step 302) and layout processed (in Step 304) have been painted before, and are only painted in 308. So the layout region is formed once and painting process is performed once. All elements of the “first screen” of the web page can be displayed on the screen at once.

A process having all of the elements painted only once can be referred to as a “forced painting” process or a “forced display” process. “Forced painting” may cause elements of a web page to appear on the display screen at once, instead of having some of the elements appear first, and some other elements appear next. For example, the first moment of the web page (e.g., a title of the page) can be displayed on the display screen first, and within a certain time length, e.g., 1 second, the display screen is filled at once, instead of filled gradually.

In other embodiments, the value of the first-screen-priority extended attribute “priority” is not “high”, Step 308 is performed for each element that has been layout processed. Thus, the layout-region-change request has been sent after the layout process for each element. The painting process may have been performed for some of the elements, so some of the elements may have been displayed on the display screen before 309. Thus, in Step 309, a painting process can be performed to paint all the elements so all the elements are displayed on the display screen, so the first screen display process of the web page is completed.

As previously described, in Step 306, when the browser-defined first-screen display strategy is satisfied, Step 309 is performed. In that case, Step 309 can further include any appropriate processes that the browser executes to perform the first-screen display of the web page according to the browser-defined first-screen display strategy.

In some embodiments, when the browser-defined first-screen display strategy is satisfied, and the value of the first-screen-priority extended attribute “priority” is “high”, Step 308 is skipped for each element that has been layout processed. Thus, in Step 309, all elements that have been parsed and layout processed can be painted in a forced painting process. The first-screen display process of the web page is thus completed.

In other embodiments, when the browser-defined first-screen display strategy is satisfied and the value of the first-screen-priority extended attribute “priority” is not “high”, Step 308 is performed for each element that has been layout processed. Thus, the layout-region-change request has been sent after the layout process for each element. The painting process may have been performed for some of the elements. Thus, in Step 309, a painting process can be performed to paint all the elements so all the elements are displayed on the display screen, so the first-screen display process of the web page is completed.

After the first screen of the page is displayed in Step 309, the browser can further process the web page for displaying a second screen, a third screen, and the like, of the web page, so a user can view more content of the pane when scrolling the pane in the browser window.

Thus, as shown in FIG. 3, Step 301 can accomplish some or all of functions similar to Step 201 as shown in FIG. 2 Steps 302-303 can accomplish some or all of functions similar to Step 202 as shown in FIG. 2. Further, Steps 304-309 can accomplish some or all of the functions similar to Steps 203-204 as shown in FIG. 2.

In Step 303, whether the element is the first-screen key element is determined. When the parsed element is the first-screen key element, Step 309 is performed, i.e. the first screen of the web page is displayed and the process for first-screen display of the web page can be completed.

When the parsed element is not the first-screen key element, in Step 305, it can be determined whether the value of the first-screen-strategy extended attribute “element-paint” is “must”. When the value of the first-screen-strategy extended. attribute “element-paint” is “must”, the next element is parsed and Steps 302-309 can be repeated for the next element.

When the value of the first-screen-strategy extended attribute “element-paint” is not “must”, Step 306 is performed, i.e., it is determined whether the browser-defined first-screen display strategy is satisfied. When the browser-defined first-screen display strategy is satisfied, Step 309 is performed, i.e. the first screen of the web page is displayed and the process for first-screen display of the web page can be completed. When the browser-defined first-screen display strategy is not satisfied, the next element is parsed and Steps 302-309 can be repeated for the next element.

In other words, the first-screen key element marks a boundary in the source code of the web page and can be used as an indicator to inform the browser that the first screen of the web page must be displayed at a time point when the first-screen key element is parsed, regardless of the value of the first-screen-strategy extended attribute “element-paint” is “must” or “optionally”. Such a process can be the same as or similar to Step 203 as shown in FIG. 2.

Further, prior to parsing of the first-screen key element, one or more elements in the source code may be parsed and layout processed. When the value of the first-screen-strategy extended attribute indicates that a page-defined first-screen display strategy is “optionally”, and the parsing and layout processing of one of the one or more prior elements causes a certain first-screen display strategy (e.g., the browser-defined first-screen display strategy) to be satisfied, the first screen of the web page can be displayed and the process for first-screen display of the web page can be completed. In this case, parsing of the first-screen key element may be performed after the process for first-screen display of the web page is completed, and is thus not included in the process for first-screen display.

Therefore, when the element is not the first-screen key element and a first-screen display criterion is met, a first screen of the web page is displayed. The first-screen display criterion can be a function of a value of the first-screen-strategy extended attribute, i.e., depends on the value of the first-screen-strategy extended attribute. In various embodiments, the first-screen display criterion can include that the value of the first-screen-strategy extended attribute indicates that a page-defined first-screen display strategy is “optional”.

In addition, the first-screen display criterion can further include satisfying a first-screen display strategy other than the page-defined first-screen display strategy. For example, a first-screen display strategy other than the page-defined first-screen display strategy can be a browser-defined first-screen display strategy. Therefore, the first-screen display criterion can further include that the browser-defined first-screen display strategy is satisfied. Thus, such a process can be the same as or similar to Step 204 as shown in FIG. 2.

Therefore, various embodiments as disclosed herein provide methods for displaying a web page. Using the disclosed methods, a first screen of the web page can be displayed faster, more accurately, and/or in such a way that a web page developer can better control the process of displaying a first screen of the web page.

As previously mentioned, a time point of first-screen display can be determined according to a position of an element. Alternatively, a time point of first-screen display can be determined according to a preset time length of opening a page. In many cases, certain types of special pages, or pages having special contents that can affect processing time, cannot be processed by the above methods used on a browser. In those cases, the first-screen display can be significantly delayed.

In the methods as disclosed in various embodiments, a web page developer can specify a first-screen key element in the metadata to mark a boundary of a first screen of a web page in the source code of the web page. Thus, at the time when the first-screen key element is parsed and recognized in the source code, the browser is configured to recognize that a time point of first-screen display is reached. As a result, even for web pages having special contents that can affect processing time, the browser can more easily determine the time point of first-screen display using the metadata. As a result, delay due to difficulty in determining the time point of first-screen display can be prevented.

Further, using the disclosed methods, a web page developer can ensure that a first screen of the web page can be displayed according to the design intention of the web page developer. For example, a browser may have a browser-defined first-screen display strategy. A web page developer may find a certain element, e.g., a figure or a title, that is crucial in presenting the first screen, and must be displayed in the first screen. However, such a crucial element may normally be parsed after the browser-defined first-screen display strategy is satisfied. In that case, the developer can use the disclosed methods to specify a first-screen key element that is parsed after the “crucial element”, and to set the value of the first-screen-strategy extended attribute “element-paint” to be “must”. Thus, the “crucial element” can be ensured to be displayed in the first screen of the web page. Even though, in this example, the actual time length needed for displaying the first screen may be longer than the time length needed for displaying the first screen using the browser-defined first-screen display strategy, content of the first screen can be consistent with the intention of the developer.

Still further, in another example, the developer can use the disclosed methods to specify a first-screen key element that is parsed before an element that satisfies the browser-defined first-screen display strategy, but after all the elements crucial to the developer. In that case the actual time length needed for displaying the first screen can be less than the time length needed for displaying the first screen using the browser-defined first-screen display strategy, and content of the first screen can be consistent with the intention of the developer.

In addition, when the browser-defined first-screen display strategy determines a time point of first-screen display according to a position of an element, and when an element has a bottom boundary beyond or exceeding the bottom boundary of the display screen, the browser determines the time point of first-screen display has been reached. However, the height of a display screen can vary, e.g., can be 3 inches, 4 inches, or any other appropriate size, depending on the specific electronic device models and manufacturers. Such a browser-defined first-screen display strategy may cause the content of the first screen of one web page to be different between two different electronic devices. Using the disclosed methods, the web page developer can define the content of the first screen of the web page, so the content of the first screen can be the same for two different electronic devices.

Moreover, the metadata can include a value of the first-screen-priority extended attribute “priority” to specify a priority for displaying the first-screen of the web page. When the value indicates that first-screen display is of high priority, a layout-region-change request is not generated after a layout process, and any potentially necessary delay due to generating the layout-region-change request can be prevented. In addition, the previously parsed and layout processed elements can be palmed all at once, i.e., painted in one single painting process without being painted prior to this one painting process (as in Step 309).

Using the disclosed methods, a developer can also be able to control a sequence or manner for the elements to appear on the first screen, e.g., whether contents of the first screen are displayed at the same time or gradually. When the value indicates that first-screen display is of high priority, the previously parsed and layout processed elements can be painted all at once as the content of the first screen (as in Step 309). That is, a first-moment display process can display certain appropriate element(s) of the web page at first, e.g., a line of text that fills 10% of the screen. Next, the first screen can be substantially completely filled at once.

Alternatively, when the value indicates that first-screen display is of normal priority, a layout-region-change request can be generated after a layout process of an element. Accordingly, the layout region may be updated as necessary. Painting of the layout region may be performed partially or entirely. Thus, during Steps 302-308, certain elements of the first screen may gradually appear on the display screen. For example, the display screen may be 25% filled, 50% filled, and displayed content may be changed for one or more times until the entire first screen is displayed in Step 309.

The metadata can be used in any web page document that is based on HTML. Although in certain embodiments, the value of the “name” attribute is “first-screen-paint”, the value of the “name” attribute can include any appropriate text string that is recognized and supported by the browser for achieving the disclosed functions. Although in certain embodiments, the key-element extended attribute is “element-id”, the key-element extended attribute can include any appropriate text string that is recognized and supported by the browser for achieving the disclosed functions.

Although in certain embodiments, the first-screen-strategy extended attribute is “element-paint” and has a value of “must” or “optionally”, the first-screen-strategy extended attribute and the values thereof can include any appropriate text strings that are recognized and supported by the browser for achieving the disclosed functions. Although in certain embodiments, the first-screen-priority extended attribute is “priority” and has a value of “high” or “normal”, the first-screen-priority extended attribute and the values thereof can include any appropriate text strings that are recognized and supported by the browser for achieving the disclosed functions.

Instructions of the name for the metadata, as well as extended attributes and values thereof, can be provided by a browser manufacturer to a web page developer in any appropriate prescribed manner, e.g., via a specification of the browser. Thus, the web page developer can add the metadata to the source code of the web page during creation of the web page.

Further, in certain embodiments, the browser can be configured to obtain the value of an extended attribute from the metadata, even when the extended attribute is not explicitly written in the metadata. In one example, the browser can be configured to choose “must” as the value of the first-screen-strategy extended attribute, when the first-screen-strategy extended attribute and the value thereof are not explicitly written in the metadata. That is, the first-screen-strategy extended attribute can have a default value of “must”, and the default value of the first-screen-strategy extended attribute can be obtained by the browser when the metadata is parsed. Alternatively, the first-screen-strategy extended attribute can have a default value of “optionally”.

In another example, the browser can be configured to choose “high” as the value of the first-screen-priority extended attribute, when the first-screen-priority extended attribute and the value thereof are not explicitly written in the metadata. That is, the first-screen-priority extended attribute can have a default value of “high”, and the default value of the first-screen-priority extended attribute can be obtained by the browser when the metadata is parsed and recognized. Alternatively, the first-screen-priority extended attribute can have a default value of “normal”.

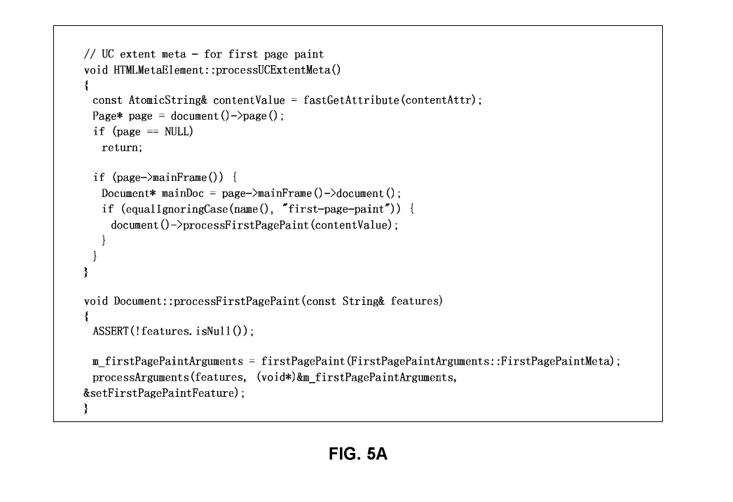

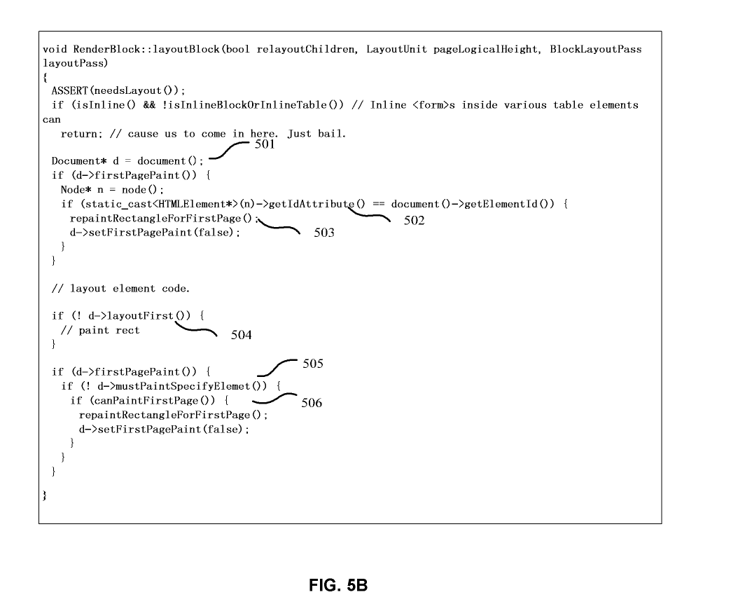

Various functions as described in the present disclosure can be carried out by an appropriate algorithm performed by a processor of an electronic device. Such an algorithm can be illustrated and implemented using coded instructions. FIG. 5A depicts a portion of coded instructions of a browser in accordance with various disclosed embodiments. FIG. 5B depicts another portion of coded instructions of a browser in accordance with various disclosed embodiments. The coded instructions as shown in can be included in the program of the browser, in such a way that the browser is configured to accomplish the functions as depicted in FIGS. 2-3. For illustrative purposes, the coded instructions are written in C++. However, any other appropriate programming languages, e.g., BASIC, Java, or the like, can also be used. Certain instructions are omitted, in order to illustrate instructions relevant to the methods as disclosed. For illustrative purposes, in the example shown in FIGS. 5A-5B, the metadata has a name of “first-page-paint”.

The coded instructions as shown in FIG. 5A can be used for parsing the meta tag as described, e.g., as in Step 301. The coded instructions as shown in FIG. 5B can be used for various processes as described, e.g., in Steps 302-309.

As shown in FIG. 5B, instruction 501 can be used for determining whether metadata tag “first-screen-paint” exists (as in Step 301). Instruction 502 can be used for determining whether an element has an ID that is the same as is the specified element ID in meta tag (as in Step 303). Instruction 503 can be used for displaying a first screen of the web page when the element is the first-screen key element (as described, e.g., in Step 309) according to result determined by instruction 502.

Instruction 504 can be used for determining whether the value of the first-screen-priority extended attribute “priority” is “high” or “normal”, as described, e.g., in Step 307. When the value of the first-screen-priority extended attribute “priority” is “normal”, Step 308 can be performed.

Instruction 505 can be used for determining whether the value of the first-screen-strategy extended attribute “element-paint” is “must” or “optionally”, as described, e.g., in Step 305. Instruction 506 can be used for determining whether the browser-defined first-screen display strategy is satisfied, as described, e.g., in Step 306.

Various embodiments further provide a method for resolving a conflict between first-screen display strategies. The method can be used for selecting a strategy between a page-defined first-screen display strategy and a browser-defined first-screen display strategy, when a conflict exists between the page-defined first-screen display strategy and the browser-defined first-screen display strategy. The method can be the same or similar to the methods as disclosed in the present disclosure, e.g., as shown in FIGS. 2-3.

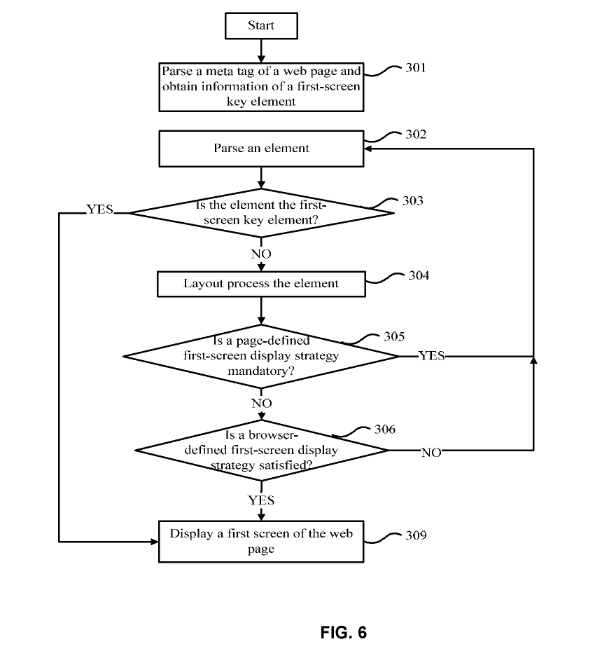

FIG. 6 depicts a flow diagram of another exemplary method for displaying a web page in accordance with various disclosed embodiments. The method as shown in FIG. 6 includes a similar process as shown in FIG. 3. However, in FIG. 6, the browser can be configured to fix the value of the first-screen-priority extended attribute “priority” to be “high”, Accordingly, Steps 307-308 in FIG. 3 may be omitted.

As shown in FIG. 6, in Step 301, metadata of a web page is obtained. For example, the metadata can be provided using a <meta> tag in HTML. The metadata can thus be obtained by parsing the <meta> tag.

In Step 302, an element is parsed. The element can be any element that the browser parses prior to displaying a first screen of the web page.

In Step 303, whether the element is the first-screen key element is determined. When the parsed element is the first-screen key element, Step 309 is performed, and Steps 304-306 are skipped. When the parsed element is not the first-screen key element. Step 304 is performed.

In Step 304, the element is layout processed. In Step 305, it is determined whether the value of the first-screen-strategy extended attribute “element-paint” is “must”. When the value of the first-screen-strategy extended attribute “element-paint” is “must”, Step 302 is performed. When the value of the first-screen-strategy extended attribute “element-paint” is not “must”, Step 306 is performed.

In Step 306, it is determined whether the browser-defined first-screen display strategy is satisfied. When the browser-defined first-screen display strategy is satisfied, Step 309 is performed. When the browser-defined first-screen display strategy is not satisfied, Step 302 is performed.

According to the functions previously described, e.g., in FIG. 3, FIG. 6 can also provide a method for resolving a conflict of first-screen display strategies.

In the methods as disclosed in various embodiments, a web page developer may desire to display a first screen of the web page in such a way that the first screen include one or more desired elements. In words, the web page developer may desire the first screen being displayed according to the web page developer's intention. The browser can be configured to have a browser-defined first-screen display strategy.

The browser-defined first-screen display strategy sometimes is unable to display exactly the one or more desired elements in the first screen. In some other cases, web page developers may create the web page to include a page-defined first-screen display strategy, and the page-defined first-screen display strategy may be different from the browser-defined first-screen display strategy. All those situations can be referred to as a conflict between the page-defined first-screen display strategy and the browser-defined first-screen display strategy.

When such a conflict exists, the browser may not be able to properly process first-screen display of a web page. Thus, first-screen display of a web page may be delayed and the first screen may be displayed inaccurately relative to the intention of the web page developer.

According to the methods as shown in FIGS. 2-3 and 6, the web page developer can specify a first-screen key element in the metadata to mark a boundary of a first screen of a web page in the source code of the web page. Thus, at the time when the first-screen key element is parsed and recognized in the source code, the browser is configured to recognize that a time point of first-screen display is reached. As a result, even for web pages having special contents that can affect processing time, the browser can more easily determine the time point of first-screen display using the metadata. So delay due to difficulty in determining the time point of first-screen display can be prevented.

Further, using the disclosed methods, a web page developer can ensure that a first screen of the web page can be displayed according to the design intention of the web page developer. In one example, the developer can set the value of the first-screen-strategy extended attribute “element-paint” to be “must”. Thus, the first screen of the web page can be displayed with exactly the elements the web page developer desires.

In another example, the developer can set the value of the first-screen-strategy extended attribute “element-paint” to be “optionally”, if the developer does not exclude the browser-defined first-screen display strategy. Thus, when the browser-defined first-screen display strategy is satisfied prior to the parsing of the first-screen key element, the first screen can be displayed. When the browser-defined first-screen display strategy is not satisfied prior to the parsing of the first-screen key element, the first screen can be displayed when the first-screen key element is parsed, so the first screen can still be displayed timely as the web page developer desires.

Various embodiments further provide a method for expediting first-screen display of a web page. The method can include performing a layout process of an element at a high priority, such that a layout-region-change request is not generated after a layout process of a prior element. Thus, any potential unnecessary delay due to generating the layout-region-change request can be prevented. The method for expediting first-screen display of a web page can be the same or similar to the methods as disclosed in the present disclosure, e.g., as shown in FIGS. 2-3.

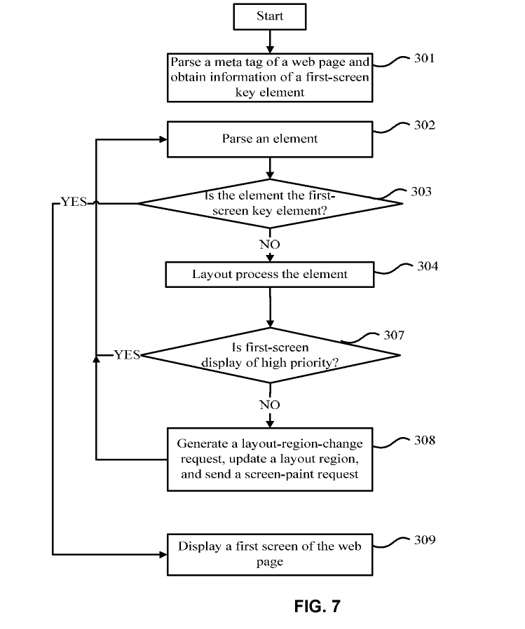

FIG. 7 depicts a flow diagram of another exemplary method for displaying a web page in accordance with various disclosed embodiments. The method as shown in FIG. 7 includes a similar process as shown in FIG. 3. However, the browser can be configured to fix the value of the first-screen-strategy extended attribute “element-paint” to be “must”. Accordingly, Steps 305-306 in FIG. 3 can be omitted.

As shown in FIG. 7, in Step 301, metadata of a web page is obtained. For example, the metadata can be provided using a <meta> tag in HTML. The metadata can thus be obtained by parsing the <meta> tag.

In Step 302, an element is parsed. The element can be any element that the browser parses prior to displaying a first screen of the web page.

In Step 303, whether the element is the first-screen key element is determined. When the parsed element is the first-screen key element, Step 309 is performed, and Steps 304, and 307-308 are skipped. When the parsed element is not the first-screen key element, Step 304 is performed.

In Step 304, the element is layout processed. In Step 307, it is determined whether the value of the first-screen-priority extended attribute “priority” is“high”. When the value of the first-screen-priority extended attribute “priority” is “high”, Step 302 is performed. When the value of the first-screen-priority extended attribute “priority” is not “high”, Step 308 is performed.

In Step 308, a layout-region-change request is generated. Responsive to the layout-region-change request, the rendering engine can re-calculate whether the layout region is changed due to the previously layout process. When the layout region has changed, a screen-paint request can be sent. Responsive to the screen-paint request, a painting process can be performed to paint and display the updated layout region. In this case, some or all of the elements that have been parsed and layout processed so far can be displayed on the screen of the electronic device. After Step 308 is performed, Step 302 can be performed. That is, a next element can be parsed.

According to the functions previously described, e.g., in FIG. 3, FIG. 7 thus also provides a method for expediting first-screen display of a web page.

Further, although for illustrative purposes, processes in FIGS. 2-3 and 6-7 may include determining whether an element is the first-screen key element, a method for expediting first-screen display of a web page may be implemented without specifying a first-screen key element, and a first-screen-strategy extended attribute may or may not be necessary.

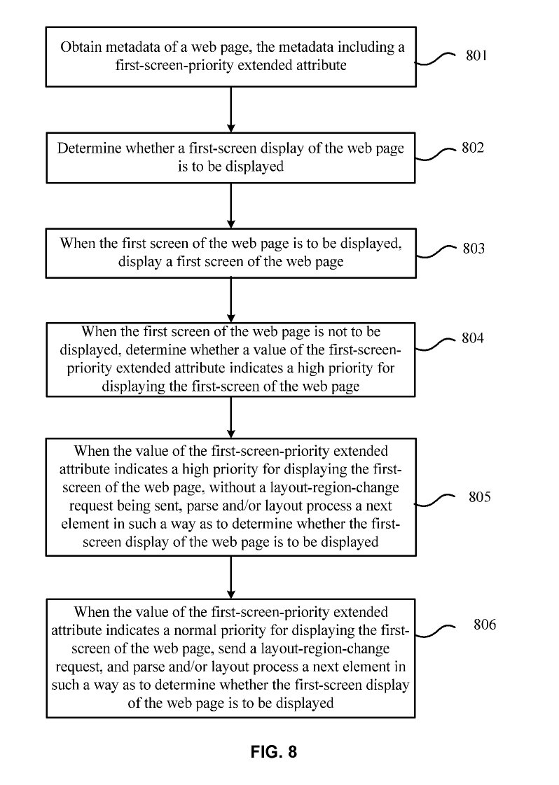

FIG. 8 depicts a flow diagram of another exemplary method for displaying a web page in accordance with various disclosed embodiments. FIG. 8 can provide a method for expediting first-screen display of a web page.

In FIG. 8, in Step 801, metadata of a web page is obtained. The metadata can have a first screen-priority extended attribute.

In Step 802, it is determined whether a first-screen display of the web page is to be displayed. In Step 803, when the first screen of the web page is to be displayed, a first screen of the web page is displayed.

In Step 804, when the first screen of the web page is not to be displayed, it is determined whether a value of the first-screen-priority extended attribute indicates a high priority for displaying the first-screen, of the web page. Step 804 can be similar to or the same as Step 307 as described, e.g., in FIGS. 3 and 7.

In Step 805, when the value of the first-screen-priority extended attribute indicates a high priority for displaying the first-screen of the web page, a layout-region-change request is not sent. A next element is parsed, or both parsed and layout processed (if layout is necessary), in such a way as to determine whether the first-screen display of the web page is to be displayed. Step 805 can be similar to or the same as the process from Step 307 to Step 302 as described, e.g., in FIGS. 3 and 7.

In Step 806, when the value of the first-screen-priority extended attribute indicates a normal priority for displaying the first-screen of the web page, layout-region-change request is sent. A next element is parsed, or both parsed and layout processed (if layout is necessary), in such a way as to determine whether the first-screen display of the web page is to be displayed. Step 806 can be similar to or the same as Step 308 as described, e.g., in FIGS. 3 and 7.

In some embodiments, the metadata does not specify a first-screen key element, and does not have a first-screen-strategy extended attribute. For example, the <meta> tag providing the metadata can have a grammar as follows:
<meta name=“first-screen-paint” content=“priority:high/normal”>

Therefore, the web page does not have a page-defined first-screen display strategy requiring a first-screen key element. In this case, in Step 802, it can be determined whether a browser-defined first-screen display strategy or any other appropriate first-screen display strategy is satisfied. When a browser-defined first-screen display strategy or any other appropriate first-screen display strategy is satisfied a first-screen display of the web page is to be displayed. When none of the browser-defined first-screen display strategy and any other appropriate first-screen display strategy is satisfied, the first-screen display of the web page is not to be displayed. Further, in Step 803, the displaying of the first screen of the web page can include similar processes as in Step 309 in FIG. 3.

In other embodiments, the metadata may be similar to the metadata as described in Step 301 in FIG. 3. That is, the metadata specifies a first-screen key element, and has a first-screen-strategy extended attribute. In that case, the web page has a page-defined first-screen display strategy requiring a first-screen key element. Thus, In Step 802, to determine whether a first-screen display of the web page is to be displayed, processes similar to Steps 303, 305 and 306 as shown in FIG. 3 can be included. Further, in Step 803, the displaying of the first screen of the web page can include similar processes as in Step 309 in FIG. 3.

As previously discussed, when the value of the first-screen-priority extended attribute indicates that first-screen display is of high priority, a layout-region-change request is not generated after a layout process, and any potentially necessary delay due to generating the layout-region-change request can be prevented. In addition, the previously parsed and layout processed elements can be painted all at once, i.e., painted in one single painting process without being painted prior to the one painting process (as in Step 309). The first-screen display of a web page can thus be expedited.

In other words, when the value of the first-screen-priority extended attribute indicates that first-screen display is of high priority, layout-region-change request and screen-paint request generated between first-moment display and first-screen display can be reduced or eliminated. The processor time and resource that is taken by painting a layout region can be reduced, and layout processes can be completed with a high priority. On the other hand, any processes that may delay first-screen display can thus have a lower priority.

When the value of the first-screen-priority extended attribute indicates that first-screen display is of normal priority, layout-region-change request and screen-paint request may be generated as in a normal process for displaying a web page where first-screen elements are parsed, layout processed and painted in a similar manner as elements of the remaining portion of the web page.

Although processes as shown in FIGS. 2-3 and 6-8 have various steps performed in certain sequences. Such sequences are for illustrative purposes only. Any other appropriate sequences may be used without deviating from the concepts and solutions as disclosed in the present disclosure.

In one example, layout process of the element does not have to be between Step 303 and Step 305. Instead, the layout process can be placed both between Step 305 and Step 306 (after determining the value of the first-screen-strategy extended attribute to not be “must”), and between Step 305 and Step 307 (after determining the value of the first-screen-strategy extended attribute to be “must”).

In another example, determining whether the browser-defined first-screen display strategy is satisfied does not require layout processing the element to be completed. Thus, the layout process of the element does not have to be prior to Step 306. Instead, the layout process can be placed between Step 306 and Step 307 (after determining the browser-defined first-screen display strategy is not satisfied), between Step 306 and Step 309 (after determining the browser-defined first-screen display strategy is satisfied), and between Step 305 and Step 307 (after determining the value of the first-screen-strategy extended attribute to be “must”). Any other processes in which the steps as shown in FIGS. 2-3 and 6-7 are performed in different sequence without deviating the disclosed concepts are intended to be encompassed within the scope of the present disclosure.

Various embodiments disclose an electronic device for displaying a web page. The electronic device can include a processor, a display system, a memory, and any other appropriate components. The memory can have encoded instructions causing the electronic device to implement the methods as described in various embodiments above, e.g., as shown in FIGS. 2-3, and 6-8.

Various embodiments also disclose an electronic device for resolving a conflict between first-screen display strategies. The electronic device can include a processor, a display system, a memory, and any other appropriate components. The memory can have encoded instructions causing the electronic device to implement the methods as described in various embodiments above, e.g., as shown in FIGS. 2-3, and 6. In various embodiments, the electronic device for displaying a web page can include a browsing module (or browser) 136, e.g., as shown in FIG. 1B. The browser can be configured to implement the disclosed method for resolving a conflict between first-screen display strategies. Further, in certain embodiments, the electronic device for resolving a conflict between first-screen display strategies can include a mobile phone, a smart phone, a tablet computer, or the like.

Various embodiments also disclose an electronic device for expediting first-screen display of a web page. The electronic device can include a processor, a display, a memory, and any other appropriate components. The memory can have encoded instructions causing the electronic device to implement the methods as described in various embodiments above, e.g., as shown in FIGS. 3, and 7-8. In various embodiments, the electronic device for displaying a web page can include a browsing module (or browser) 136, e.g., as shown in FIG. 1B. The browser can be configured to implement the disclosed method for expediting first-screen display of a web page. Further, in certain embodiments, the electronic device for expediting first-screen display of a web pate can include a mobile phone, a smart phone, a tablet computer, or the like.

In various embodiments, the methods as disclosed can be implemented by software coupled with certain necessary universal hardware platform. The methods as disclosed can also be implemented by hardware. Part or it of the steps in the methods in accordance with various embodiments can be accomplished using a program/software to instruct related hardware. The program/software can be stored in a (non-transitory) computer-readable storage median including, e.g., Read-Only Memory (ROM), RAM, internal memory, register, computer hard disk, removable disk, CD-ROM, optical disk, floppy disk, magnetic disk, or the like. The program/software can include coded instructions to instruct a computer system e.g., a client device, to execute the methods in accordance with various embodiments. The client device can include, e.g., a mobile phone, a smart phone, a tablet computer, a general-purpose computer, or the like.

As used herein, the terms “include”, “comprise”, “contain”, or any other variations thereof, are intended to cover a non-exclusive inclusion, such that a process, method, article, or apparatus that includes a series of elements can not only include those elements, but also include other elements not expressly listed, or inherent elements for such a process, method, article, or apparatus. Without further limitation, an element defined by a statement “include one . . . ” does not exclude additional identical elements that may be included in the process, method, article, or apparatus that includes the element.

The embodiments disclosed herein are exemplary only. Other applications, advantages, alternations, modifications, or equivalents to the disclosed embodiments are obvious to those skilled in the art and are intended to be encompassed within the scope of the present disclosure.

### INDUSTRIAL APPLICABILITY AND ADVANTAGEOUS EFFECTS

Without limiting the scope of any claim and/or the specification, examples of industrial applicability and certain advantageous effects of the disclosed embodiments are listed for illustrative purpose. Various alternations, modifications, or equivalents to the technical solutions of the disclosed embodiments can be obvious to those skilled in the art and can be included in this disclosure.

The disclosed methods and electronic devices for displaying a web page can be used in a variety of mobile device applications that involve receiving and displaying information. The applications can include, but are not limited to, displaying a web page on a mobile phone, a tablet computer, a personal digital assistant, a POS (point of sales), a car-carried-computer, or any other desired electronic devices.

Using the methods in accordance with various embodiments, metadata of a web page can be obtained. The metadata can specify a first-screen key element and include a first-screen-strategy extended attribute A value of the first-screen-strategy extended attribute can indicate whether a page-defined first-screen display strategy is mandatory or optional. An element can be parsed in such a way as to determine whether an element of the web page is the first-screen key element. When the element is the first-screen key element, a first screen of the web page can be displayed. When the element is not the first-screen key element and a first-screen display criterion is met, a first screen of the web page can be displayed. The first-screen display criterion cart be a function of the value of the first-screen-strategy extended attribute.

Using the disclosed methods, a first screen of the web page can be displayed faster, more accurately, and/or in such a way that a web page developer can better control the process of displaying a first screen of the web page.

Even for web pages having special contents that can affect processing time, the browser can more easily determine the time point of first-screen display using the metadata. As a result, delay due to difficulty in determining the time point of first-screen display can be prevented.

Further, using the disclosed methods, a web page developer can ensure that a first screen of the web page can be displayed according to the design intention of the web page developer. In addition, the web page developer can define the content of the first screen of the web page, so the content of the first screen can be the same for two different electronic devices.

Moreover, the metadata can include a value of the first-screen-priority extended attribute “priority” to specify a priority for displaying the first-screen of the web page. When the value indicates that first-screen display is of high priority, a layout-region-change request is not generated after a layout process, and any potentially necessary delay due to generating the layout-region-change request can be prevented. The previously parsed and layout processed elements can be painted all at once, i.e., painted in one single painting process without being painted prior to this one painting process. Furthermore, a developer can also be able to control a sequence of appearance of the elements on the first screen, e.g., whether contents of the first screen are displayed at the same time or gradually.

1. A method for displaying a web page, comprising:
obtaining metadata of a web page, the metadata specifying a first-screen key element and including a first-screen-strategy extended attribute, a value of the first-screen-strategy extended attribute indicating whether a page-defined first-screen display strategy is mandatory or optional;
parsing an element of the web page in such a way as to determine whether the element is the first-screen key element;
when the element is the first-screen key element, displaying a first screen of the web page; and
when the element is not the first-screen key element and a first-screen display criterion is met, displaying a first screen of the web page, the first-screen display criterion being a function of the value of the first-screen-strategy extended attribute.

2. The method according to claim 1, wherein the first-screen display criterion includes:
the value of the first-screen-strategy extended attribute indicating that the page-defined first-screen display strategy is optional.

3. The method according to claim 2, wherein the first-screen display criterion further includes:
a browser-defined first-screen display strategy being satisfied.

4. The method according to claim 1, wherein the metadata further includes a first-screen-priority extended attribute, a value of the first-screen-priority extended attribute indicating whether a priority for displaying the first-screen of the web page is high or normal.

5. The method according to claim 4, wherein, when the element is not the first-screen key element and the first-screen display criterion is not met, the method further includes:
when the value of the first-screen-priority extended attribute indicates that the priority for displaying the first-screen of the web page is high, proceeding to parse a next element of the web page without sending a layout-region-change request; or
when the value of the first-screen-priority extended attribute indicates the priority for displaying the first-screen of the web page is normal, sending a layout-region-change request and parsing a next element of the web page.

6. The method according to claim 4, wherein, when the value of the first-screen-priority extended attribute indicates the priority for displaying the first-screen of the web page is high, the displaying of the first screen of the web page includes:
painting all of elements of the first screen in one painting process, none of the elements of the first screen being painted prior to the one painting process.

7. The method according to claim 5, wherein, when the value of the first-screen-priority extended attribute indicates the priority for displaying the first-screen of the web page is normal, and after sending a layout-region-change request, the method further includes:
updating a layout region of the first screen of the web page; and
sending a screen-paint request for painting the updated layout region.

8. An electronic device for displaying a web page, comprising a processor, a display system, and a memory, the memory having thereon encoded instructions that causes the electronic device to display a web page on the display system by a process comprising:
obtaining metadata of a web page, the metadata specifying a first-screen key element and including a first-screen-strategy extended attribute, a value of the first-screen-strategy extended attribute indicating whether a page-defined first-screen display strategy is mandatory or optional;
parsing an element of the web page in such a way as to determine whether the element is the first-screen key element;
when the element is the first-screen key element, displaying a first screen of the web page; and
when the element is not the first-screen key element and a first-screen display criterion is met, displaying a first screen of the web page, the first-screen display criterion being a function of the value of the first-screen-strategy extended attribute.

9. The electronic device according to claim 8, wherein the first-screen display criterion includes:
the value of the first-screen-strategy extended attribute indicating that the page-defined first-screen display strategy is optional.

10. The electronic device according to claim 9, wherein the first-screen display criterion further includes:
a browser-defined first-screen display strategy being satisfied.

11. The electronic device according to claim 8, wherein the metadata further includes a first-screen-priority extended attribute, a value of the first-screen-priority extended attribute indicating whether a priority for displaying the first-screen of the web page is high or normal.

12. The electronic device according to claim 11, wherein, when the element is not the first-screen key element and the first-screen display criterion is not met, the process further includes:
when the value of the first-screen-priority extended attribute indicates drat the priority for displaying the first-screen of the web page is high, proceeding to parse a next element of the web page without sending a layout-region-change request; or
when the value of the first-screen-priority extended attribute indicates the priority for displaying the first-screen of the web page is normal, sending a layout-region-change request and parsing a next element of the web page.

13. The electronic device according to claim 11, wherein, when the value of the first-screen-priority extended attribute indicates the priority for displaying the first-screen of the web page is high, the displaying of the first screen of the web page includes:
painting all of elements of the first screen in one painting process, none of the elements of the first screen being painted prior to the one painting process.

14. The electronic device according to claim 12, wherein, when the value of the first-screen-priority extended attribute indicates the priority for displaying the first-screen of the web page is normal, and after sending a layout-region-change request, the process further includes:
updating a layout region of the first screen of the web page; and
sending a screen-paint request for painting the updated layout region.

15. A non-transitory computer-readable storage medium having thereon executable computer programs which causes an electronic device to display a web page by a process comprising:
obtaining metadata of a web page, the metadata specifying a first-screen key element and including a first-screen-strategy extended attribute, a value of the first-screen-strategy extended attribute indicates whether a page-defined first-screen display strategy is mandatory or optional;
parsing an element of the web page in such a way as to determine whether the element is the first-screen key element;
when the element is the first-screen key element, displaying a first screen of the web page; and
when the element is not the first-screen key element and a first-screen display criterion is met, displaying a first screen of the web page, the first-screen display criterion being a function of the value of the first-screen-strategy extended attribute.

16. The non-transitory computer-readable storage medium according to claim 15, wherein the first-screen display criterion includes:
the value of the first-screen-strategy extended attribute indicating that the page-defined first-screen display strategy is optional.

17. The non-transitory computer-readable storage medium according to claim 16, wherein the first-screen display criterion further includes:
a browser-defined first-screen display strategy being satisfied.

18. The non-transitory computer-readable storage medium according to claim 15, wherein the metadata further includes a first-screen-priority extended attribute, a value of the first-screen-priority extended attribute indicating whether a priority for displaying the first-screen of the web page is high or normal.

19. The non-transitory computer-readable storage medium according to claim 18, wherein, when the element is not the first-screen key element and the first-screen display criterion is not met, the process further includes:
when the value of the first-screen-priority extended attribute indicates that the priority for displaying the first-screen of the web page is high, proceeding to parse a next element of the web page without sending a layout-region-change request; or
when the value of the first-screen-priority extended attribute indicates the priority for displaying the first-screen of the web page is normal, sending a layout-region-change request and parsing a next element of the web page.

20. The non transitory computer-readable storage medium according to claim 18, wherein, when the value of the first-screen-priority extended attribute indicates the priority for displaying the first-screen of the web page is high, the displaying of the first screen of the web page includes:
painting all of elements of the first screen in one painting process, none of the elements of the first screen being painted prior to the one painting process.
